(19) United States
(12) Patent Application Publication
(10) Pub. No.: US 2014/0043492 A1
(43) Pub. Date: Feb. 13, 2014

(54) Multi-Light Source Imaging For Hand Held Devices

(71) Applicants: Bernhard Geiger, Cranbury, NJ (US); Thomas O'Donnell, New York, NY (US)

(72) Inventors: Bernhard Geiger, Cranbury, NJ (US); Thomas O'Donnell, New York, NY (US)

(73) Assignee: Siemens Corporation, Iselin, NJ (US)

(21) Appl. No.: 13/568,489

(22) Filed: Aug. 7, 2012

(51) Int. Cl. H04N 5/225

(52) U.S. Cl. 348/207.1; 348/222.1; 348/E05.024

(57) ABSTRACT

Systems and methods are provided to record at least a first and a second image of a marking on a surface of an object with a mobile computing device including a processor, a display and a camera with a lens. The lens and the display are located at the same side of the body of the computing device. The first image is taken with a first part of the display illuminating the object and the second image is taken with a second part of the display illuminating the object illuminating the object from different directions. Different illumination directions provide different shadow effects related to ridges and grooves on the surface. Processing the images which are substantially registered allows extraction of markings created by ridges and or grooves on the surface of the object. Computer tablets and smart phones perform the steps of the present invention.

### FIELD OF THE INVENTION

The present invention relates generally to taking multiple images with a single camera applying different light sources. The invention in particular relates to taking images with a single camera in a computing device with a display that is used as a variable light source.

### BACKGROUND OF THE INVENTION

It can be, in certain circumstances, desirable to analyze geometric features of an object. Of importance can be embossed or raised lines, characters, or scratches. It would be valuable in many circumstances if these features could be easily analyzed.

It would be beneficial if a surface of an object could be analyzed instantly with a readily available device containing a camera. Many people nowadays have and operate mobile computing devices, such as smart phones and tablet computers that are enabled to creating, recording and processing images. However, it is believed that currently no general purpose mobile computing devices with cameras are available that can analyze a surface of an object by using a display of the device as a light source to create differently illuminated scenes of the surface.

Accordingly, novel and improved methods and computing devices integrated with a camera and a display are required to generate a plurality of images of a scene including a surface of an object, wherein the scene is exposed to different illuminations.

### SUMMARY OF THE INVENTION

Aspects of the present invention provide systems and methods to detect a pattern on a surface of an object by taking with a camera in a mobile computing device a first image and a second image of the surface, wherein the first image applies a first activated part of a display in the mobile computing device for illumination of the surface and the second image applies a second activated part of the display in the mobile computing device for illumination of the surface. In accordance with an aspect of the present invention a method is provided to record an image of a marking on a surface of an object, comprising illuminating an area of the surface of the object by activating a first part of a display in a mobile computing device, recording with a camera in the mobile computing device a first image of the area of the surface illuminated by the activated first part of the display, illuminating the area of the surface of the object by activating only a second part of the display in the mobile computing device, recording with the camera a second image of the area of the surface illuminated by the activated second part of the display and a processor processing the first and second image to provide an extraction of the marking.

In accordance with a further aspect of the present invention a method is provided, wherein the extraction of the marking is based on a difference image of the first and the second image.

In accordance with yet a further aspect of the present invention a method is provided, wherein the first and the second image are substantially registered images.

In accordance with yet a further aspect of the present invention a method is provided, wherein a light color of an activated part of the display is a non-white color.

In accordance with yet a further aspect of the present invention a method is provided, wherein the mobile computing device is selected from the group including a computing tablet with a camera lens and the display located at the same side of a body of the mobile computing device and a smart phone with a camera lens and the display located at the same side of a body of the mobile computing device.

In accordance with yet a further aspect of the present invention a method is provided, wherein the first part and the second part of the display are determined during a calibration.

In accordance with yet a further aspect of the present invention a method is provided, further comprising the processor applying an image feature extraction process.

In accordance with yet a further aspect of the present invention a method is provided, further comprising recognizing a pattern from the image feature.

In accordance with yet a further aspect of the present invention a method is provided, further comprising connecting the mobile computing device with a database server via a network.

In accordance with yet a further aspect of the present invention a method is provided, further comprising obtaining instructions to perform the steps of the method of claim 1 from a web site.

In accordance with another aspect of the present invention a mobile computing apparatus is provided to record an image of a marking on a surface of an object, comprising a memory to hold and to retrieve data from, a display, a camera, a processor enabled to execute instructions to perform the steps: instructing the display to activate a first part of the display to illuminate an area of the surface of the object, instructing the camera to record a first image of the area of the surface illuminated by the activated first part of the display, instructing the display to activate a second part of the display to illuminate the area of the surface of the object, instructing the camera to record a second image of the area of the surface illuminated by the activated second part of the display and processing the first and second image to provide an extraction of the marking.

In accordance with yet another aspect of the present invention a mobile computing apparatus is provided, wherein the extraction of the marking is based on a difference image of the first and the second image.

In accordance with yet another aspect of the present invention a mobile computing apparatus is provided, wherein the first and the second image are substantially registered images.

In accordance with yet another aspect of the present invention a mobile computing apparatus is provided, wherein the activated first part of the display emits light of a different color than the activated second part of the display part of the display.

In accordance with yet another aspect of the present invention a mobile computing apparatus is provided, wherein the mobile computing device is selected from the group including a computing tablet with a camera lens and the display located at the same side of a body of the mobile computing device and a smart phone with a camera lens and the display located at the same side of a body of the mobile computing device.

In accordance with yet another aspect of the present invention a mobile computing apparatus is provided, wherein the first part and the second part of the display are determined during a calibration.

In accordance with yet another aspect of the present invention a mobile computing apparatus is provided, further comprising the processor applying an image feature extraction process.

In accordance with yet another aspect of the present invention a mobile computing apparatus is provided, further comprising the processor recognizing a pattern from the image feature.

In accordance with yet another aspect of the present invention a mobile computing apparatus is provided, wherein the mobile computing device is connected with a database server via a network.

In accordance with yet another aspect of the present invention a mobile computing apparatus is provided, further comprising obtaining instructions from a web site.

### BRIEF DESCRIPTION OF THE DRAWINGS

FIGS. 1 and 2 illustrate mobile computing devices in accordance with various aspect of the present invention;

FIGS. 3, 4 and 5 illustrate a mobile computing device with a display and a camera in accordance with at least one aspect of the present invention;

FIG. 6 illustrates images generated in accordance with at least one aspect of the present invention;

FIGS. 7 and 8 illustrate a mobile computing device in accordance with various aspect of the present invention;

FIG. 9 illustrates a networked system in accordance with an aspect of the present invention; and

FIG. 10 illustrates a system enabled to perform steps of methods provided in accordance with various aspects of the present invention.

### DETAILED DESCRIPTION

Many objects, such as parts in a machine or a turbine, have identifying engravings or stampings or embossed geometric features, that allows for instance to track a history or to re-order the part in case of maintenance.

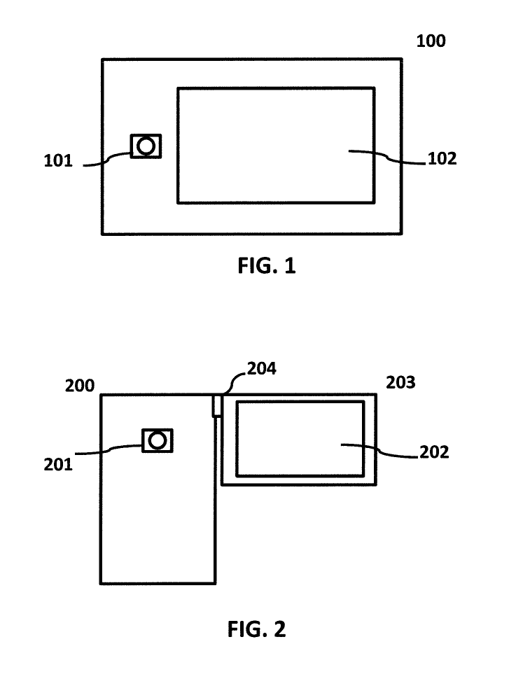

It would be helpful if one could take a picture of such markings and automatically read the markings, which have some fixed geometric features, for recognition and identification of a part or object. Mobile phones and mobile computing devices such as computing tablets are available in configurations wherein a camera or a camera lens and a display are pointed in one direction such as illustrated in FIG. 1, wherein a body of the computing device contains of course components of a computer, including a processor and a lens 101 that is part of an imaging unit that includes an image sensor and a display, preferably a color display 102. The camera can be applied to record individual still images as well as video images. The display has a refresh rate that is at least several frames per second, preferably at least 10 frames per second and most preferably at least 24 frames per second. Such a configuration allows users of the device for instance to take their own picture.

In the configuration of FIG. 1 the display 102 and camera 101 are captured in one body. A different configuration is a camera as illustrated in FIG. 2 with first body 200 which contains a lens 201 of a camera with an image sensor and a second body 203 containing a display connected and attached to 200 by a hinge mechanism that allows the display to be turned in different positions. Several video cameras on the market have this feature.

These video cameras with the separately movable display use this display as a viewer for a user. However, in one embodiment of the present invention, the video camera is provided with a processor that can instruct the display to display a specific pre-programmed screen, which can be a screen that is illuminated in one part and dark in another part. The camera may store images on a local storage device such as a memory device or a disk or transfer image data to an external device.

One position would be the display 202 facing the user while the camera lens 201 is directed away from the user. In a second position the display is moved through mechanism 204 in such as way that both the lens and the display are facing in a same direction or about the same direction.

Most displays in a computing device are active devices which radiate light. These include Liquid crystal display with backlight, LED, and plasma display. Passive displays work by modulating light for instance by reflection. In accordance with an aspect of the present invention camera and display of the computer device are oriented or capable of being oriented in substantially one direction and the display is enabled to emit light from a display area that is activated by a processor. The display in one embodiment of the present invention is thus enabled to directly illuminate a scene that is being recorded by the camera.

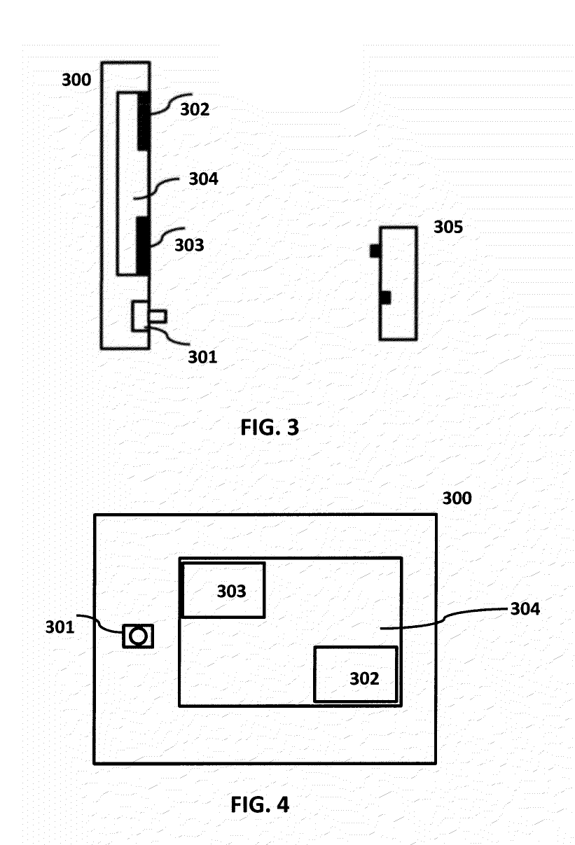

FIG. 3 illustrates the configuration of FIG. 1 in cross section with a view from above. In FIG. 3, 300 is the body of the computer device, 301 is the camera and 304 is the display. Furthermore, areas 302 and 303 in the display are identified as areas that are used to create illumination of an object 305, which has an outward ridge and a groove. Ridges and grooves will create a shadow under illumination, which will differ with different illuminations.

FIG. 4 illustrates the device 300 of FIG. 3 in a frontal view. Areas 302 and 303 in one embodiment are used for illumination. This means that at one moment the display except for identified area 303 is dark and area 303 is for instance white or any other useful color, such as red, blue, green or any other shade or color. One may also provide an illuminating patch with one of different intensities, ranging from a highest intensity to a low intensity. One may also create a patch of a mix of smaller illuminated patches with different colors and/or intensities.

On a second moment the display except area 302 is dark and area 302 is for instance white or any other useful color. If the device 300 is held in substantially one place the effect is that object 305 is illuminated at moment one from one direction determined by area 303 with a predetermined color or spectrum and at moment two object 305 is illuminated from a second direction by area 302 with a predetermined color or spectrum.

The camera can be manually activated to record an image following a change in illumination by a pre-determined area. Preferably and in accordance with an aspect of the present invention the camera and the display are synchronized by a program executed by a processor in the device. Based on a location of a ridge or a groove on an object, the distance of the camera to the object, the size of a ridge or a groove, the height or depth of a ridge or a groove and if a pattern is formed by ridges or grooves, the pattern, spectrum, position, shape and intensity of illuminated areas can be set by the program. In one embodiment of the present inventions at least two different illumination areas are of equal size and are provided with the same color and intensity at different times. In one embodiment of the present invention the areas are rectangles. However they can be of different shapes, including circles, ellipses, polygons, triangles or any other shape that is useful.

Depending on the size of the display and the distance of the camera to the object the distance of the at least two areas is determined. Furthermore, as an example two illuminated areas were provided. It should be clear that more than two illumination areas can be programmed and synchronized with the camera. In one embodiment of the present invention three or more illumination areas are provided. In one embodiment of the present invention up to ten illumination areas are provided. In one embodiment of the present invention eleven or more illumination areas are provided.

In one embodiment of the present invention an area is homogeneous in color and/or intensity. In one embodiment of the present invention intensities and/or colors within an area are different. In one embodiment of the present invention intensities and/or colors between areas are different and at least one color of generated light is not white. This is helpful in situation with for instance different types of materials or different textures or different colors of materials.

The color of light generated by the display is defined as the code for the display provided or instructed by the processor. There are different types of display coding schemes for instance one hexadecimal color code provided as an HTML tag is #FFFFFF for white, #000000 for black, #FF0000 for red and #0000FF for blue, and #0000A0 for dark blue and all other shades determined by the hexadecimal code. A RGB code will have R=255, G=255 and B=255 for white or H=0°, S=0% and V=0% for white. Accordingly, when a processor provides a code for activating a part of a display with a non-white color, such code is any code but the one that determines white. Any other code than the code for white thus provides as shade or color that is non-white.

In one embodiment of the present invention, the frame recording speed of the camera can be set by the processor as well as the trigger moment to record an image. The processor is also programmed to illuminate certain areas of the display in a preset pattern with set colors, intensities, shapes, size and position of the areas. For instance, the processor will illuminate 4 rectangular areas in the corners of the display at different moments with the same color and intensity at different times. In order to limit the time between different images, it is preferable to record images as quickly as possible. In one embodiment of the present invention, the camera takes 2 or more images per second, each image being associated with a different area of illumination of the display. In one embodiment of the present invention, the camera is synchronized in such a way that a new area is illuminated with at least one complete frame display time for the display to stabilize and the camera recording a picture in the middle of a frame display time. Depending on the available intensity of light, one may need at least two display frame times to record the image. The display will switch to a new area after recording has been stopped, and the cycle may start over again.

The moment of recording thus is determined by the processor and is synchronized with the display. The camera may have a sensor to determine light conditions. The camera may also have a focus sensor to determine a distance to the object to set a focal setting to a lens. The intensity of the illumination area and the time and synchronization of the camera and the illumination areas of the display may be determined by the light and distance reading of these sensors.

Different conditions, such as light conditions, distance to the object and depth or height of grooves and ridges may require different display and camera settings. Some of the conditions of these settings may be detected automatically and leading to automatic settings by the processor. Some settings may be derived from imaging results. For instance two images created with different illumination areas of the display and an intensity setting may be compared or processed for instance by subtracting one image from the other. It is noted that for image subtraction to work for feature detection, two images must be aligned or aligned substantially in a same reference frame. Image alignment or registration methods are known and may be part of a repertoire of available programs to a processor in the device. Substantially aligned means that within the resolution of the display at least one landmark in two images is aligned or registered over a predefined distance. For instance an edge of an object in two images or a pattern on the surface for instance within an area of 1 by 1 cm2 is registered. Such a registered pattern or edge is preferably close to the mark that needs to be detected.

By subtracting the two aligned images the processor can decide automatically or interactively with a user to change settings or leave them unchanged. For instance, a device with a defined display may have a preferred distance to an object that is defined by the minimum focus distance of the camera. As the display is closer to the object that is to be photographed or recorded, it allows more light to be cast on the object compared to a condition wherein the display is farther removed. A display that is closer to the object also allows for a greater angle between the illuminated path of the display and the object. A selected distance depends on the size of the display, the power generated by the illuminated patch of the display, the location of the illuminated patch on the display and the depth or height of the feature on the object.

For instance, assume a minimum distance of 15 cm. The shorter the distance of the display to the object the greater the potential variance in lighting angle if one considers the two opposite corners of the display and the greater the variance in shadows created. Very superficially modified surfaces will generate almost no differences in images in shadows, while deep grooves or significant ridges will create significant changes in shadows due to different illumination angles. Accordingly, in one embodiment of the present invention a setting of a device with a display for taking images based on at least two illuminations generated by the display is set for an object at a first distance of the display to the object for a change in surface features that are about 0.1 mm or smaller. In one embodiment of the present invention a setting of a device with a display for taking images based on at least two illuminations generated by the display is set for an object at a first distance of the display to the object for a change in surface features that are about 0.5 mm or smaller. In one embodiment of the present invention a setting of a device with a display for taking images based on at least two illuminations generated by the display is set for an object at a first distance of the display to the object for a change in surface features that are about 1 mm or smaller.

The settings of the display including the illuminated patches, the color and intensities and size of the patches, the preferred distance to an object, the timing of the illumination and preferred image processing steps and the like, depend on the conditions of creating the images, the condition of the object, the properties of the camera and the size and properties of the display. For instance, a larger display can have a further separation of the illuminated display patches and can be placed further away from the object while still creating illumination conditions from useful different directions. A faster camera having a more sensitive image sensor requires less intensive illumination and/or uses faster shutter times. This allows taking a rapid series of images with different illuminations and making the system more stable over a short period of time.

Taking into account different conditions and requirements, a camera with display illumination in one embodiment of the present invention takes images of an object with different illuminations by the display from a distance to the object ranging from 5 cm to 25 cm; in one embodiment of the present invention from a distance to the object ranging from 10 cm to 50 cm; and in one embodiment of the present invention from a distance to the object not greater than 1 m.

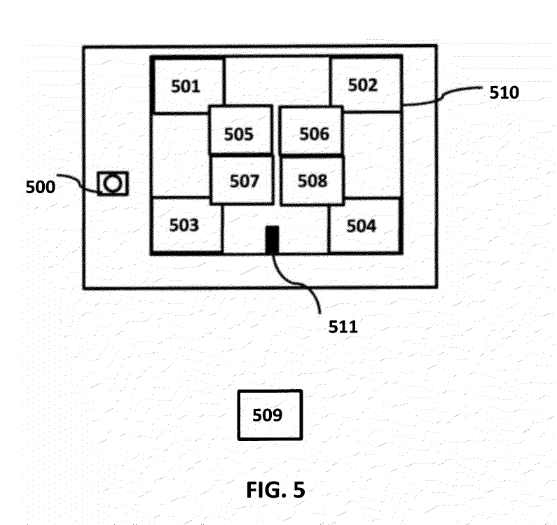

In one embodiment of the present invention, the processor will take a number of images of the object, each image being associated with a different illuminated part of the display. The object is preferably illuminated by at least two different patches in the display. This is illustrated in FIG. 5. In one embodiment, a camera 500 records an image of object 509 with each image being associated with a different patch in display 510. While 2 images are a minimum requirement in accordance with an aspect of the present invention, the processor can take of course more than 2 images each associated with a different patch on the display. For instance, at one distance of the object 509 from the camera 500, the processor takes images associated with patches 501, 502, 503 and 504 being illuminated. At another distance, patches 505, 506, 507 and 508 are used. The position of object 509 relative to the camera also will influence which parts of the display will generate the best results.

The orientation of the display and the position of the display and the camera relative to the object will have an effect on how the object is to be illuminated and how the image processing and with which procedures the processing will take place. Based on a distance to an object and on an orientation of the device, and for instance determined during a calibration, the processor has stored in a memory a preferred illumination and a preferred relative position of the display with relation to the object. The processor may indicate that position with a set-up mark 511, allowing a user to align the display with the mark to a center of an object, or part of the object that is being imaged.

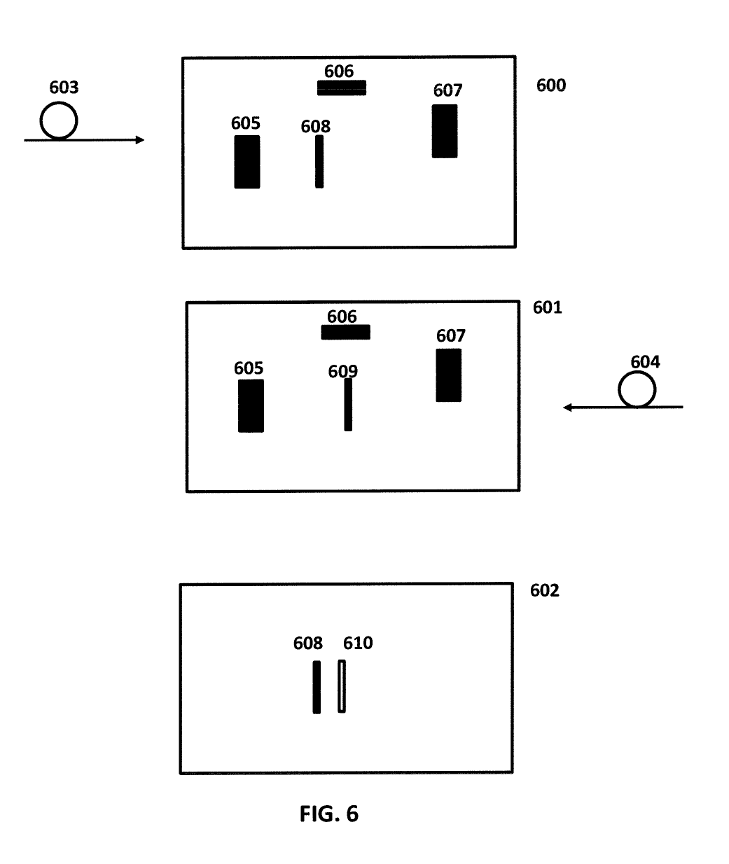

The imaging process is illustrated in diagram in FIG. 6. Image 600 is recorded with the camera in the device and part 603 of the display acting as a light source. The image 600 contains images of objects 605, 606, 607 and 608 and is stored in memory. Then the image 601 is recorded with the camera in the device and part 604 of the display acting as a light source. The camera has not been moved during the two images. The image 601 contains images of objects 605, 606, 607 and 609 and is also stored memory. Image 602 contains the subtraction of 601 from 600. Objects 605, 606 and 607 are flat patterns on the object and are not significantly changed by different light sources. Both objects 608 and 609 are raised or sunken relative to the surface of the object and may be part of a stamp or relief on the object. Subtraction of 601 from 600 will create a result that shows 608 and the negative of 610, but eliminates the other objects.

Other image processing techniques such as grey scale conversion, filtering, feature extraction, including Canny edge detection, Harris corner detection and Hough line detection, threshold detection and the like can be used to pre-process or post process images to detect the edges of raised or sunken (relief) features on an object.

Many portable and mobile computing devices nowadays contain one or more orientation sensors, which allow the processor to determine an orientation of the display. In most cases the use of an orientation sensor is applied to determine the way the display displays images and text or a specific display plane of the device. Usually this determines the vertical orientation of the displayed images on the screen. The orientation of course also determines the relative position of the camera relative to orientation. It may be that it is beneficial to orient the display and thus the camera with an object which may not coincide with the horizontal or vertical edges of the display. Based on data generated by the one or more orientation sensors in the device an optimal illumination pattern is generated by the processor, corresponding to the sensed orientation of the device.

In accordance with at least one aspect of the present invention, a mobile computing device is applied in one or more calibration conditions, wherein an optimal illumination pattern is determined and programmed into the device. The illumination patterns may be different for different conditions and may depend on distance of the device to an object, light conditions, orientation of the computing device and properties of the features on the object that have to be detected. Features with a strong relief on an object may require different illumination and/or image processing steps.

In accordance with one aspect of the present invention at least one object is applied during calibration with a defined relief which is used to determine a best illumination, a preferred number of images required and corresponding to a specific illumination, a best distance, and a best relative position and orientation of the device relative to the object and the best one or more imaging processing steps.

In accordance with an aspect of the present invention, calibration is applied to an object with different relief features, such as raised or sunken features with different dimensions. For each type of feature an optimal illumination and image processing may be determined that is stored in a memory in the device and that can be retrieved during an operation of the device by a user.

In accordance with an aspect of the present invention a calibration object is provided with different features in different areas on the object. These areas are identified as different calibration areas. As part of an operational use, a user may use the calibration object to assess the condition of the object to be analyzed with the conditions of the calibration object. The user may select the preferred setting corresponding with a calibration area to select a setting of the device for illumination and image processing. During operation a user may select a setting and apply the device for illumination, recording and analysis for a first time. The user may select interactively areas for improved discrimination of features and areas of irrelevance which can be ignored for processing. This will create a new setting allowing the processor to improve performance in detection of features on an object, for instance by ignoring other areas or limiting image areas for processing.

In one embodiment of the present invention, consecutive images are taken fast enough so that no camera movement takes place between two images. In one embodiment of the present invention a camera movement is expected to occur between two images that are used to extract a feature of an object based on at least two different illuminations. To counter camera movement one can apply camera stabilization techniques, which may include image registration. To facilitate image registration one may attach a mark, such as an image of a rectangle or triangle on the object. Such a mark is useful if no other clear features such as object edges or the like are within the field of view of the camera. The processor then aligns or registers the images using object features or user added features. Registration preferably takes place before any other image processing to assure that the registration features will not be modified by the image processing. Temporary image processing, such as feature extraction, may be applied during image registration.

One may also apply the device to confirm that no major features or artifacts occur in a certain area of an image. The processor provides an illumination that is optimal for a position of the camera and provides at least two different illuminations by the display. After image subtraction, no significant features may be discernible in the subtraction image, confirming that no significant features of a certain dimension are present in that area.

In accordance with an aspect of the present invention, the methods and device as provided herein in accordance with various aspects of the present invention are used to detect, and/or display and/or recognize geometric variations on a surface of an object that are difficult to detect from a single image using a single light source, like embossed print, raised areas, scratches, wear patterns and textures.

An embossed or raised pattern on an object may be text or a bar code or a Quick Response Code used for scanning by a mobile phone camera. These patterns may have faded or covered in such a manner that a single image will not enable recognition. In that case the methods and devices as provided herein can be useful. In that case it is also beneficial to include recognition software for recognizing text, or bar codes or any other code for the processor.

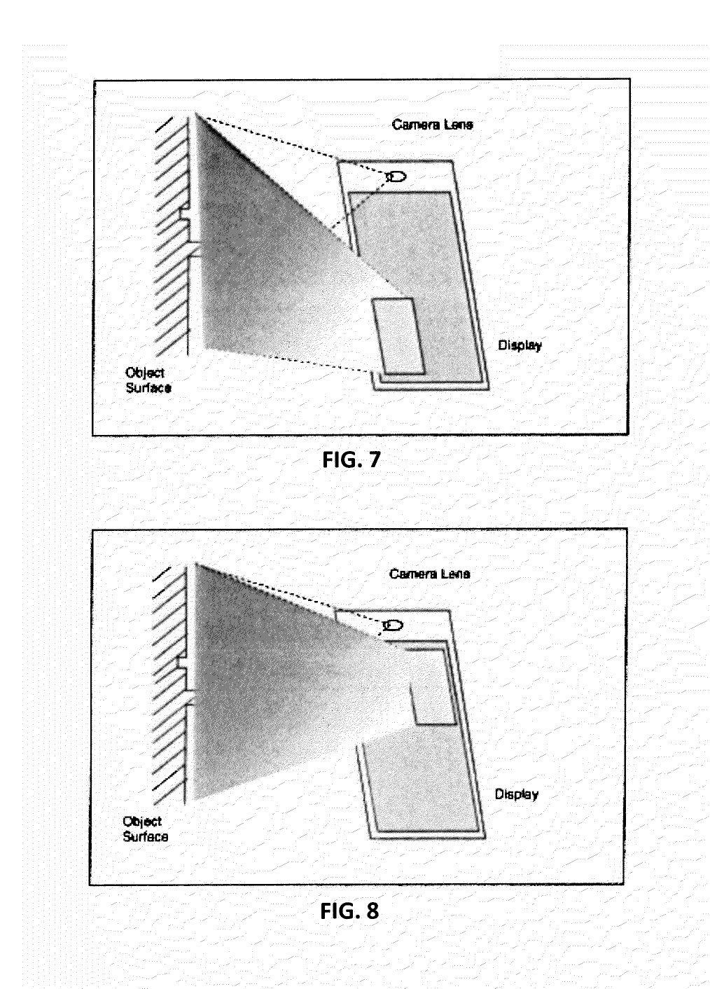

FIGS. 7 and 8 illustrate the recordings of two images by a camera of an object illuminated by different bright or activated parts of a display. The camera, light source and processor to control the light source and perform processing are thus all part of a single device in one body, or in one combined body having connected parts.

Mobile phones or smart phones such as the iPhone® and tablets such as the iPad® have all the components as required herein i.e. a processor, a display and a camera at the display side of the device. Applications that run on portable and mobile computing devices are available for downloading on web sites that are called application stores or app-stores. In one embodiment of the present invention the instructions that are optimal for recording images with different illuminations are packaged in a downloadable app. In one embodiment of the present invention an app is optimized for a specific device. In one embodiment of the present invention an object is provided with different raised and embossed patterns which an app can recognize and to which it is optimized.

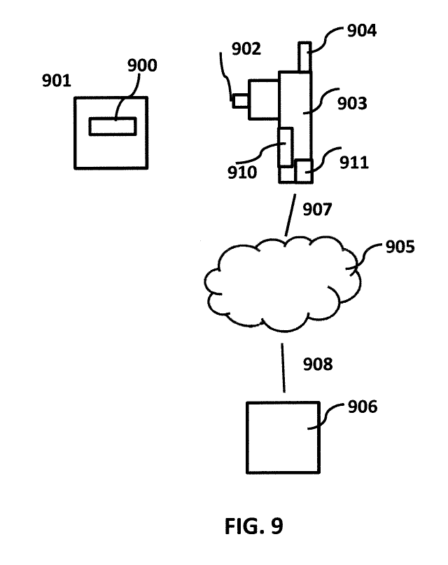

In one embodiment of the present invention the camera in a mobile computing device with a display at the same side of the body as the camera is part of a system. This is illustrated in FIG. 9. The mobile computing device 903 with a camera 902 and a display 910 and a processor 911 and an antenna 904 is enabled to communicate via a communication channel 907 over a network 905 which may be the Internet and via a connection 908 to a server 906. The camera 902 takes at least one image of an object 901 with a marking 900 to analyze the marking and determine its meaning.

In one embodiment, the processor 911 analyzes at least two images of 900 taken by camera 902 and illuminated by display 910. Processor 911 may determine for instance that marking 900 is an alpha-numeric marking or code and transmits the code to server 906.

Server 906 includes a database that has details related to the code 900 and may inform a user via display 910 that object 901 is a certain part X of a machine Y, installed on a certain date and that replacement of object 901 as part of preventive maintenance is required within 60 days and offers the capability to order the part and schedule its replacement.

In one embodiment of the present invention the processor generates an image of a feature or a marking or a code detected on an object from the at least two images taken from the object and displays it on the display. Such an image may serve as an opportunity to perform a check on the image, for instance to determine if characters have been recognized. In some situations viewing an extracted image may not be useful for a user, for instance because it requires a statistical analysis to determine some pattern of wear and tear for instance. In that case only data may be generated that represents the extracted marking but that is not viewed on the display, but will be transferred to another computer or processor for further analysis. In one embodiment of the present invention data extracted from the images may not even be image data but a code or a meaning of a code.

In one embodiment of the present invention the server 906 includes powerful image processing or machine vision software and receives the images captured by camera 902 for further processing.

In accordance with an aspect of the present invention, the processor on the camera device is unable to determine or analyze or recognize a meaningful marking on a surface of an object, such as characters, symbols or code or the like. In accordance with an aspect of the present invention the camera is able to recognize and analyze the marking by using at least two images from a same point of view taken from the object by a camera in a mobile computing device with a display, camera and display facing the object, wherein at least a first and a second area only of the display activated by the processor serve as different sources of illumination of the object for the camera. In one embodiment of the present invention the marking or feature on the object to be recognized has a height difference of at preferably least 0.05 mm or more preferably of at least 0.1 mm.

In order to provide meaningful image subtraction between the at least first and second images, these images must be substantially registered. Substantially registered herein means that displayed elements or pixels in the images that are not affected by a change in lighting direction (or do not cast shadows) will appear at the same coordinates in an image display. In other words, the camera has not moved, or the images have been moved in such a manner that it appears the camera related to the registered feature has not moved.

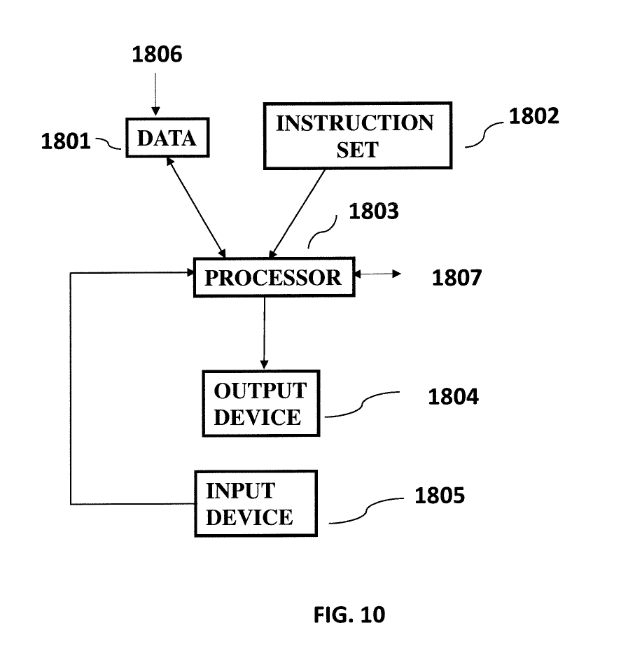

The methods as provided herein are, in one embodiment of the present invention, implemented on a system or a computer device. Thus, steps described herein are implemented on a processor, as shown in FIG. 10. A system illustrated in FIG. 10 and as provided herein in accordance with an aspect of the present invention is enabled for receiving, processing and generating data. The system is provided with data that can be stored on a memory 1801. Data may be obtained from a sensor such as a camera or from any other data relevant source. Data may also be provided on an input 1806. Such data may be image data or any other data that is helpful in a system as provided herein. The processor is also provided or programmed with an instruction set or program executing the methods of the present invention that is stored on a memory 1802 and is provided to the processor 1803, which executes the instructions of 1802 to process the data from 1801. Data, such as display control data or any other data triggered or caused by the processor can be outputted on an output device 1804, which may be a display to display part of a screen as a bright area to illuminate a scene, or to a data storage device. The data from images can also be stored in memory 1802. The processor also has a communication channel 1807 to receive external data from a communication device and to transmit data to an external device. The system in one embodiment of the present invention has an input device 1805, which may include a keyboard, a mouse, a pointing device, one or more cameras or any other device that can generate data to be provided to processor 1803.

The processor can be dedicated or application specific hardware or circuitry. However, the processor can also be a general CPU, a controller or any other computing device that can execute the instructions of 1802. Accordingly, the system as illustrated in FIG. 10 provides a system for processing data resulting from a sensor or any other data source and is enabled to execute the steps of the methods as provided herein as one or more aspects of the present invention.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims.

1. A method to record an image of a marking on a surface of an object, comprising:
illuminating an area of the surface of the object by activating a first part of a display in a mobile computing device;
recording with a camera in the mobile computing device a first image of the area of the surface illuminated by the activated first part of the display;
illuminating the area of the surface of the object by activating only a second part of the display in the mobile computing device;
recording with the camera a second image of the area of the surface illuminated by the activated second part of the display; and
a processor processing the first and second image to provide an extraction of the marking.

2. The method of claim 1, wherein the extraction of the marking is based on a difference image of the first and the second image.

3. The method of claim 1, wherein the first and the second image are substantially registered images.

4. The method of claim 1, wherein a light color of an activated part of the display is a non-white color.

5. The method of claim 1, wherein the mobile computing device is selected from the group including a computing tablet with a camera lens and the display located at the same side of a body of the mobile computing device and a smart phone with a camera lens and the display located at the same side of a body of the mobile computing device.

6. The method of claim 1, wherein the first part and the second part of the display are determined during a calibration.

7. The method of claim 1, further comprising:
the processor applying an image feature extraction process.

8. The method of claim 7, further comprising:
recognizing a pattern from the image feature.

9. The method of claim 1, further comprising:
connecting the a mobile computing device with a database server via a network.

10. The method of claim 1, further comprising:
obtaining instructions to perform the steps of the method of claim 1 from a web site.

11. A mobile computing apparatus to record an image of a marking on a surface of an object, comprising:
a memory to hold and to retrieve data from;
a display;
a camera;
a processor in communication with the memory, the display and the camera and enabled to execute instructions to perform the steps of:
instructing the display to activate a first part of the display to illuminate an area of the surface of the object;
instructing the camera to record in the memory a first image of the area of the surface illuminated by the activated first part of the display;
instructing the display to activate a second part of the display to illuminate the area of the surface of the object;
instructing the camera to record in the memory a second image of the area of the surface illuminated by the activated second part of the display; and
processing the first and second image to provide an extraction of the marking.

12. The mobile computing device of claim 11, wherein the extraction of the marking is based on a difference image of the first and the second image.

13. The mobile computing device of claim 11, wherein the first and the second image are substantially registered images.

14. The mobile computing device of claim 11, wherein the activated first part of the display emits light of a different color than the activated second part of the display part of the display.

15. The mobile computing device of claim 11, wherein the mobile computing device is selected from the group including a computing tablet with a camera lens and the display located at the same side of a body of the mobile computing device and a smart phone with a camera lens and the display located at the same side of a body of the mobile computing device.

16. The mobile computing device of claim 11, wherein the first part and the second part of the display are determined during a calibration.

17. The mobile computing device of claim 11, further comprising:
the processor applying an image feature extraction process.

18. The mobile computing device of claim 17, further comprising:
the processor recognizing a pattern from the image feature.

19. The mobile computing device of claim 11, wherein:
the mobile computing device is connected with a database server via a network.

20. The mobile computing device of claim 11, further comprising:
obtaining instructions for the processor from a web site.
